(19) United States
(12) Patent Application Publication
(10) Pub. No.: US 2016/0328721 A1
(43) Pub. Date: Nov. 10, 2016

(54) Lead Management Systems

(71) Applicant: Underground Elephant, San Diego, CA (US)

(72) Inventors: Jason Kulpa, San Diego, CA (US); Keola Malone, San Diego, CA (US); Jovel Lacson, Chula Vista, CA (US); Kevin McCarroll, San Diego, CA (US); Aaron Scherer, San Diego, CA (US)

(21) Appl. No.: 15/015,083

(22) Filed: Feb. 3, 2016

Related U.S. Application Data
(60) Provisional application No. 62/158,462, filed on May 7, 2015.

(51) Int. Cl. G06Q 30/02

(52) U.S. Cl. CPC G06Q 30/0201

(57) ABSTRACT

Managing online sales lead information by receiving sales lead information over the Internet from an online sales lead source. At least some of the sales lead information is validated by the execution of validation rules that normalize the format and/or identity of the sales lead information. A scoring algorithm is executed for each of the validated sales lead information to generate a score based on one or more attributes of the validated sales lead information. A representation of validated sales leads is generated for validated sales lead information having a score above a minimum threshold. The representation having a format that is readable by a client and displayable on the user display associated with the client.

### CROSS REFERENCE TO RELATED APPLICATIONS

This application claims the benefit of priority under 35 U.S.C. §119(e) of U.S. Provisional Application Ser. No. 62/158,462, filed May 7, 2015, titled “Lead Management Systems,” the disclosure of which is hereby incorporated by reference in its entirety herein.

### TECHNICAL FIELD

The subject matter described herein relates to managing the provision of sales lead information between sales lead sources to sales lead buyers over a distribution network.

### BACKGROUND

Companies, as part of their advertising campaigns, pay for sales leads. Such sales leads may be provided over electronic communication mediums. Some entities may receive sales lead information that is valuable to other entities. The sales lead collecting entities may provide the sales leads to companies that desire sales leads. The companies that desire sales leads may pay the sales lead collecting entities for the sales leads. The manner in which the sales lead purchasers value sales leads can be different depending on various factors of the sales leads including the source, the mode of transmission, or the like.

### SUMMARY

In one aspect, a method of managing lead sources is provided. The method can be performed by at least one data processor forming at least part of a computing system. The method can include the performance of one or more operations. The operations can include receiving, by the at least one data processor, sales lead information over the Internet from an online sales lead source. One or more validation rules can be executed. The one or more validation rules can be implemented in executable software. The validation rules can normalize a format and/or identity of the sales lead information to validate at least some of the sales lead information based on the one or more validation rules and to generate validated sales lead information. A scoring algorithm can be executed. The scoring algorithm can calculate a score based on one or more attributes of the validated sales lead information to generate a score for each of the validated sales lead information according to the scoring algorithm. A representation of validated sales leads can be generated. The representation can be generated for delivery to a client having a user display for presentation on the user display. The representation can be generate for validated sales lead information having a score above a minimum threshold. Validating of the at least some sales lead information can put the at least some of the sales lead information into a format displayable on the display device.

Sales lead sources may include one or more of: web-based forms, third-party client relationship management software, third-party lead management software, a call center, and/or a web page.

The validation rules may include cross-referencing at least some of the sales lead information against information provided by a third party to normalize the format and/or identity of the sales lead information. The validation rules may include cross-referencing at least some of the sales lead information against one or more information databases to normalize the format and/or identity of the sales lead information.

The method may comprise generating, by at least one data processor, a score for each of the validated sales lead information according to a scoring algorithm executed by the at least one data processor, the scoring algorithm calculating the score based on one or more attributes of the validated sales lead information.

The method may comprise determining, by at least one processor, in response to validating the sales lead information and generating a score for the validated sales lead information that is in excess of a minimum threshold, a client for the validated sales lead information. The method may comprise electronically offering, by at least one processor, a bid price from the client to the sales lead source. The method may comprise receiving, by at least one processor, an acceptance of the offer from the sales lead source, and wherein delivering the validated sales lead information to the client is performed in response to receiving the acceptance of the offer from the sales lead source.

The method may comprise generating, by at least one data processor for delivery to a client, a representation of validated sales leads based on the validated sales lead information having a score above a minimum threshold. Validated sales lead information may be delivered to the client by one or more of electronic mail, POST, GET, Ping/Post, Push FTP, and/or Pull FTP.

In some variations, the method may comprise receiving, by at least one data processor, sales information from the client, and wherein generating a score of the validated sales lead information includes generating a score for the validated sales lead information based on the received sales information.

The method may comprise augmenting, by at least one data processor, in response to validating at least some of the sales lead information, the sales lead information by integrating at least some of the sales lead information with information obtained from one or more information databases.

The method may comprise generating the validated sales lead information for delivery to a client is performed, by at least one data processor, in response to one or more predefined triggers.

The method may comprise tracking, by at least one data processor, sales lead information received from the sales lead source. The method may comprise providing, by at least one data processor, an indication of the validity of at least some of the sales lead information to the sales lead source that provided the sales lead information.

In some implementations, the sales lead information provided by the sales lead source prior to validation may contain partial sales lead information and wherein the sales lead information provided to the client in response to receiving an acceptance of the offer from the sales lead source includes full sales lead information.

In some implementations, receiving, by at least one data processor, sales lead information from a sales lead source may further comprises: providing, by at least one processor, to the sales lead source an electronic messaging address, the electronic messaging address configured to receive lead source information from the sales lead source; and, verifying, by the at least one processor, that the lead source information submitted to the electronic messaging address complies with a predetermined specification.

In some implementations, receiving, by at least one data processor, sales lead information from a sales lead source may further comprise: polling, by at least one processor, an internet location associated with the sales lead source for sales lead information; and parsing, by at least one processor, sales lead information from the internet location associated with the sales lead source.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a lead management system, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is an illustration of a system having one or more features consistent with implementations of the current subject matter;

FIG. 2 is a process flow diagram illustrating aspects of a method having one or more features consistent with implementations of the current subject matter;

FIG. 3 is a process flow diagram illustrating aspects of a method having one or more features consistent with implementations of the current subject matter;

FIG. 4 is a process flow diagram illustrating aspects of a method having one or more features consistent with implementations of the current subject matter;

FIG. 5 is a process flow diagram illustrating aspects of a method having one or more features consistent with implementations of the current subject matter;

FIG. 6 is an illustration of lead information across verticals and lead clients that have been generated by a lead management system capable of performing one or more of the operations described herein;

FIG. 7 is an illustration of key performance indicators for sales leads that have been generated by a lead management system capable of performing one or more of the operations described herein;

FIGS. 8 and 9 are illustrations of incoming leads that have been received and filtered by a lead management system capable of performing one or more of the operations described herein;

FIG. 10 is an illustration of lead metrics filtered by different lead attributes that have been generated by a lead management system capable of performing one or more of the operations described herein; and,

FIG. 11 is an illustration of leads received by a lead management system capable of performing one or more of the operations described herein.

### DETAILED DESCRIPTION

The present disclosure relates to facilitating and managing the providing of sales lead information from a lead source to a lead client/buyer. Such facilitation and management may be performed by a lead management system. In some implementations, a lead management system may receive sales leads from sales lead sources. The lead source may include webforms. In some implementations, the webforms may be provided by the lead management system operator. The sales lead information may be validated by the lead management system. After validating the sales lead information, the sales leads may be scored and matched to potential lead clients/buyers. After being scored and matched sales lead information may be distributed to lead clients/buyers as appropriate.

In some implementations lead information may be received and validated in real time or near real time. In some implementations, validating and/or scoring the lead information may be done to the extent necessary to distribute those leads with the highest propensity to convert. The lead management system may be configured to receive real time sales lead information, historic sales lead information, or other sales lead information.

The lead management system may be configured to process a wide array of business rules provided by lead clients/buyers. The business rules may include highly custom business rules. The lead management system may provide a level of automation to avoid the need for human intervention. The lead management system may be provided with one or more target metrics, such as revenue, profit, lead quality, and/or other target metrics. The lead management system may be configured to automatically maintain the target metrics without human intervention.

The lead management system may be configured to access a lead management database. The lead management database may be configured to store lead sales information, scoring information associated with the sales leads, and/or other information associated with the sales lead information. The lead management system may be configured to manage the lead management database. The lead management system may be configured to augment the lead management database with third party data received by the lead management system. The lead management system may be configured to monitor rules and/or restrictions associated with third party services and/or databases. The lead management system may be configured to handle third party information in accordance with the rules and/or restrictions.

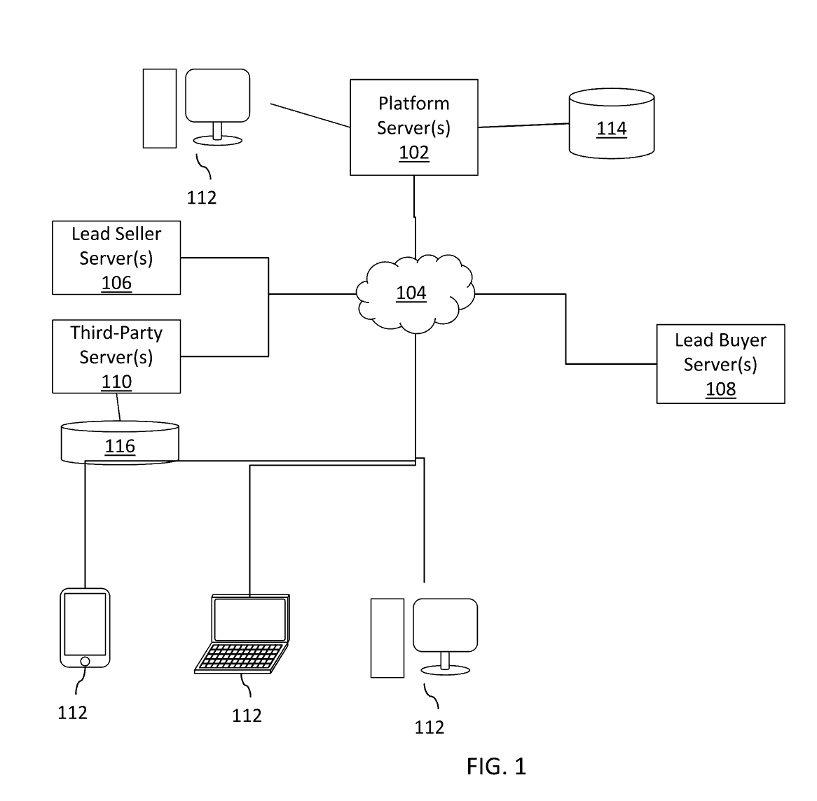

FIG. 1 is an illustration of an exemplary system 100 having one or more features consistent with the present subject matter. The system 100 may include one or more platform servers 102. The platform server(s) 102 can be configured to facilitate one or more of the operations described herein. The platform server(s) 102 can be operated by an entity that manages lead information. The term server as used herein may refer to a computing resource that manages centralized access to resources over a network, a computing device, a mobile computing device, or the like.

The platform server(s) 102 can be in electronic communication with a network 104, such as the Internet. The platform server(s) 102 can communicate, through the network 104, with one or more lead seller server(s) 106 and one or more lead buyer server(s) 108. The lead seller server(s) 106 can be operated by an entity configured to generate sales leads, or other types of leads. Leads being information associated with a lead entity that can provide a value to a lead buyer. Lead buyer server(s) 108 can be operated by entities that buy leads in order to target lead entities associated with the leads and extract value out of those lead entities.

The platform server(s) 102 can be in electronic communication with one or more third-party servers 110. Third-party servers 110 can be operated by entities that provide services to the lead seller, lead buyer, or the operator of the platform server(s) 102.

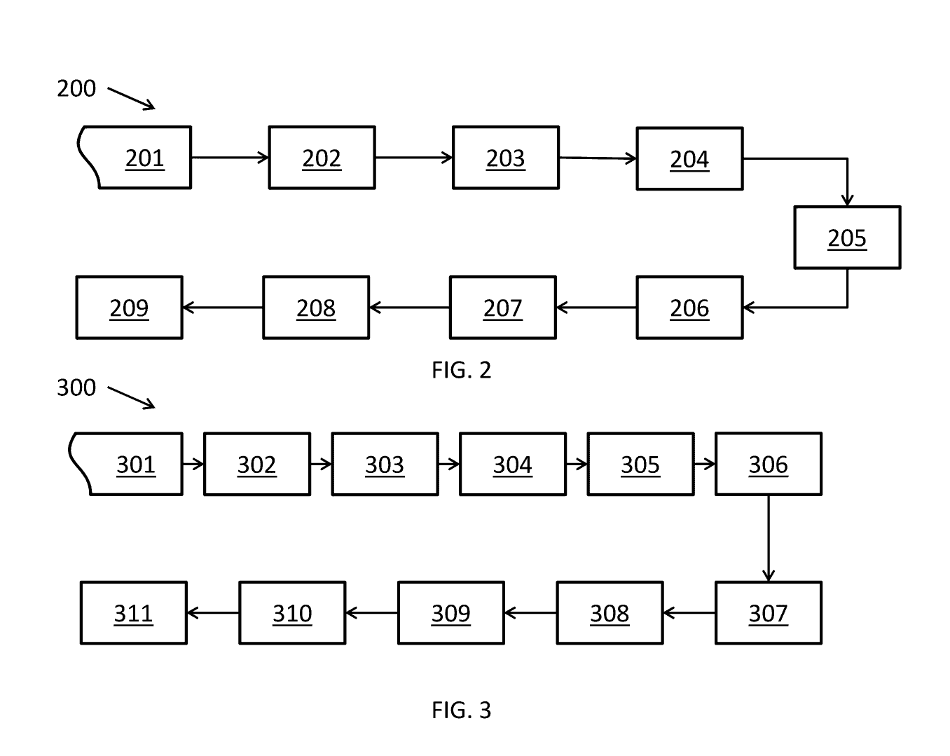

One or more operations of the platform server(s) 102 can be managed by user device(s) 112. User device(s) 112 can be connected to the platform server(s) 102 through a local area network, wide area network, such as the Internet, or the like. Various confirmations can be handled through the user device(s) 112. For example, in transaction-based arrangements, authorization to complete a transaction may be required from an administrator. The platform server(s) 102 can be configured to transmit a confirmation to a user device(s) 112. In some applications multiple confirmations may be required from administrators associated with different user devices 112. The platform server(s) 102 can be configured to transmit requests for authorization to the multiple user devices 112. Similarly, authorization to complete transactions may be hierarchical requiring successive levels of authorization. The platform server(s) 102 can be configured to manage the hierarchical authorization process.FIG. 2 is a process flow diagram 200 illustrating aspects of a method having one or more features consistent with implementations of the current subject matter. The operations illustrated in FIG. 2 may be performed by a platform configured to manage sales lead information. The platform may be managed and maintained by the platform server(s) 102.

At 201 lead information may be received. Lead information may be received from a lead selling entity. In some variaitions, the lead information may be received at the platform server(s) 102 from the lead seller server(s) 106. A lead may be a consumer having interest or inquiry into products or services of an organization. Lead information may relate to leads created for any purpose. Some purposes may include generating leads for distribution of information. Other purposes may include generating leads for the purposes of selling services or products to individuals or organizations associated with those leads. Organizations strive to generate “quality” leads which are those leads having a higher probability of converting into a desired outcome. The lead information may be received from a lead source. Leads may be received from any source and/or vertical. Sources may include, for example, digital sources, such as through the Internet, personal referrals, lead vendors, call centers, through advertisements, events, and other lead sources. In some variations, leads may be acquired from lead marketplaces such as post or pingpost.

At 202 at least some of the sales lead information may be validated to generate validated sales lead information. The sales lead information may be validated based on one or more validation rules. The validation rules may be configured to normalize the format and/or identity of the sales lead information.

In some implementations, the one or more validation rules may include cross-referencing at least some of the sales lead information against information provided by a third party to normalize the format and/or identity of the sales lead information. The one or more validation rules may include cross-referencing at least some of the sales lead information against one or more information databases to normalize the format and/or identity of the sales lead information. In some variations, the platform server(s) 102 may be in electronic communication with one or more local databases 114. In some variations, the platform server(s) 102 may be in electronic communication with one or more remote databases 116 maintained by third-parties. The remote database(s) 116 may be accessed through a third-party server(s) 110.

In some implementations, the validation rules may audit several data points contained in the sales lead information. The validation rules may be customized. The validation rules may check sales lead information attributes. Such attributes may include the Internet Service Provider (ISP), the Internet Protocol (IP) address, or other electronic information used by the sales lead source, the sales lead, or other parties. Such attributes may include User Agent information which may maintain custom rules or blacklists of certain sales lead sources and/or sales leads. The system may integrate with third party services to validate sales lead information. For example, the third party services may facilitate the validation of addresses, telephone numbers, email addresses and/or other sales lead information. For example, a given street address may or may not match with a given zip code. Third party services may be used to verify such information. Such third-party services may include services provided through third-party server(s) 110. In some variations, information may be transmitted from the third-party server(s) 110 to the platform server(s) 102. In other variations, lead information may be transmitted from the platform server(s) 102 to the third-party server(s) 110 for verification by third-party services.

The validation rules may verify that the sales leads and/or the sales lead sources comply with one or more regulations. For example, the validation rules may verify that the sales leads associated with the sales lead information have properly opted in. The validation rules may verify that the sales lead information, the associated sales leads, and the sales lead sources comply with the Telephone Consumer Protection Act (TCPA). The validation rules may remove duplicate entries. One of ordinary skill in the art will understand and appreciate that the validation rules may be added to, or customized, ad infinitum.

In some implementations, the sales lead information may comprise multiple fields. Certain ones of these fields may be so-called “required fields.” These required fields may be validated first by the one or more validation rules. In response to an indication that these required fields fail to meet certain minimum standards or fail certain validation rules a notification may be provided to the sales lead source that the sales lead information provided failed the validation process.

At 203 sales lead information received from sales lead sources may be augmented. The sales lead information may be augmented using information already obtained that is associated with individual or groups of sales leads. In some variations, the information may be managed by the platform server(s) 102 on electronic storage 114, or database. The sales lead information may be augmented using information from third party sources. In some variations, the information may be managed by the third part server(s) 110 on electronic storage 116, or database. For example, at least some of the sales lead information associated with a sales lead may be used to obtain additional information about that sales lead. A zip code or IP address may be used to obtain information associated with the geographical location of the sales lead. An email address may be used to identify social profiles associated with the sales lead. Social profile information may include information to augment with the received sales lead information. A phone number or name may be used to find an address, or vice versa. Public databases may be used to determine home ownership information property tax information, professional qualifications and/or other information. A database may be maintained by the recipient of the sales lead information and/or a third party in which to derive information from associated with the sales lead information.

Augmenting the sales lead information may include cleansing the sales lead information. The sales lead information may comprise spelling mistakes. Spelling mistakes may be determined based on reference to common dictionary spellings of certain words. Spelling mistakes may be determined based on consulting one or more databases to determine the likely intended word based on other information provided with the sales lead information. Historical databases may be used to check for obviously bad data, such as the name associated with the sales lead information being “Mickey Mouse” or “Winnie the Pooh.” Any validation system may be used.

In some implementations, throughout the validation at 102 and augmentation at 103 the status of the sales lead information may be updated. Such statuses may include “valid,” “invalid,” “pending review,” “duplicate,” “DNC,” and/or any other status identifier.

In some implementations, at 202 or 203, data may be validated and/or augmented by sending the sales lead information to a third-party service, for example, from the platform server(s) 102 to the third-party server(s) 110. The third-party service may respond with a score for the accuracy of the information and may include additional information associated with the sales lead information. For example, secondary telephone numbers, secondary addresses, correct addresses, current/previously aliases and/or other information may be provided by a third-party service.

At 204, triggers may be configured and associated with individual sales leads. Triggers may be configured to perform actions associated with sales leads. Such actions may include whether to permit autodialing, sending of SMS messages, sending of email messages and/or other actions. The validation rules may be used to control the triggers that are bound to each sales lead.

At 205, a score may be generated, by one or more physical processors, for example, one or more physical processors of the platform server(s) 102, for each of the validated sales lead information. The score may be generated according to a scoring algorithm executed by the at least one data processor of the platform server(s) 102. The scoring algorithm may include calculating the score based on one or more attributes of the validated sales lead information.

Generating a score may include generating a score associated with at least some of the validated sales lead information for a given buyer of sales lead information. In some implementations sales leads may be routed for delivery to a buyer. The sales lead information may be matched to the right buyers based on generating a score associated with the sales lead information for that buyer. The scoring algorithm may be configured to maximize the return on investment for the buyer of sales lead information, the seller of sales lead information, and/or both the buyer and seller of sales lead information. In some implementations, the scoring algorithm may be configured to generate an overall score for the sales lead information. The scoring algorithm may be configured to generate a plurality of individual scores for the sales lead information as it applies to a plurality of individual buyers of sales lead information.

At 206, buyer information may be received. The buyer information may be received at the platform server(s) 102. In some variations, the one or more platform server(s) may receive buyer information from a lead buyer server(s) 108. The buyer information may relate to buyers of sales lead information. Buyer information may include geolocation, consumer data, potential product type and/or other information type. In some implementations, at 106, buyer information may be generated for sets of sales lead information. In some implementations, at 106 buyers may be filtered for the received sales lead information. The received sales lead information may include one or more attributes. The one or more attributes may provide an indication as to appropriate buyers for that particular sales lead information. The attributes may be used by the one or more processors to facilitate the generation of one or more buyer filters. The one or more buyer filters may be applied to the buyer information and filter the buyers to ones that are most appropriate for the sales lead information.

Buyer information may be filtered to optimize sales lead quality, buyer return on investment, sales lead generators, or a combination thereof. A buyer's return on investment may be determined based on the cost to acquire the sales lead, the media costs in acquiring the sales lead, potential revenues from the sales lead, historical performance of the buyer and/or similar sales leads.

At 206, in response to validating the sales lead information at 102 and generating a score for the validated sales lead information that is in excess of a minimum threshold at 105, the platform server(s) 102 may be configured to generate a lead information data file. The lead information data file may comprise one or more fields. The lead information data file may include fields for values indicating the level of validity, the score, the lead source, the lead value, and/or the like. The lead information data file may be configured to be transmitted between the platform server(s) 102 and the lead buyer server(s) 108. The lead information data file may be configured such that the lead information data file cannot be read by any unintended recipients. Protecting the lead information data file from being read by unintended recipients can facilitate protecting the value added to the lead information by the platform server(s) 102.

At 207, a buyer, for the validated sales lead information, may be determined. In some implementations, the buyer may be notified of the sales lead information. The sales lead information may be accompanied with a level of validity and/or the score determined at 205 for the sales lead information. The lead information data file, generated at 206, and having a proprietary format may be received by the lead buyer server(s) 108. The lead buyer server(s) 108 may be configured to analyze the proprietary lead information data file. The lead buyer server(s) 108 may be configured to determine a value of the lead information contained in the lead information data file from the one or more fields of the lead information data file.

A bid price may be electronically received from the buyer to the sales lead information. The bid price may be transmitted from the lead buyer server(s) 108 to the platform server(s) 102. The bid price from the sales lead buyer may be electronically communicated to the sales lead source. In some variations, the bid price can be transmitted from the platform server(s) 102 to the lead seller server(s) 106.

In some variations, the sales lead buyer may provide a bid price for sales leads that have one or more desired attributes. The sales lead buyer may provide a range of bid prices for sales leads having a range of desired attributes. The sales lead buyer may provide the platform server(s) 102 with the information prior to sales leads becoming available such that as soon as a sales lead matching the sales lead buyer's desires attributes, the platform server(s) 102 can be configured to cause a bid to be placed on behalf of the sales lead buyer for that sales lead. In other variations, the platform server(s) 102 can be configured to request a bid price from the lead buyer server(s) 108. The sales lead buyer server(s) 108 may comprise administrator-provided ranges for bid prices for sales leads having one or more desired attributes. The sales lead buyer server(s) 108 may comprise complex logic for determining bid price. For example, when the sales lead buyer determines that it has previously purchased above a threshold amount of a sales lead having a certain attribute, the sales lead buyer may provide complex logic that causes the bid price for those types of sales leads to be reduced, and other types of sales leads to be increased to increase the chances of the sales lead buyer obtaining those types of sales leads.

Similarly, the lead selling entity may similarly have complex logic to determine the minimum value for the sales lead information.

The platform server(s) 102 may be configured to determine an appropriate price for the sales lead information. The platform server(s) 102, based on seller parameters and buyer parameters may determine a price for the sales lead information that maximizes the value to both the seller and the buyer of the sales lead information.

The platform server(s) 102 may be configured to monitor the trade in sales lead information on its own platform as well as on third-party platforms. The platform server(s) 102 may be configured to monitor the availability and the price paid for certain types of sales leads and determine a likely value of the sales lead information. The platform server(s) 102 may be configured to determined a likely value of the sales lead information for the market as a whole, for groups or types of sales lead sellers and buyers, for individual sales lead sellers and buyers, or the like. Operations performed by the platform server(s) 102 are provided in more detail below.

In response to the sales lead source accepting the bid price offered by the client, the validated sales lead information may be provided to the client at 208.

The sales lead information provided to the client prior to acceptance of the bid price by the sales lead source may comprise partial sales lead information. The sales lead information provided to the client in response to receiving an acceptance of the bid price from the sales lead source may include an increased amount of sales lead information.

At 206 and/or 207, the sales lead information may be examined and matched to prospective buyers. The matching may be done in accordance with one or more buyer filters. The one or more buyer filters may be buyer-provided filters giving indications of the types of sales lead information that the buyer wishes to receive. Additionally, the one or more buyer filters may be lead management system—provided filters corresponding to features paid for by buyers. At 206 and/or 207, a pool of potential buyers may be determined by matching the sales lead information with the buyers. Sales lead information and/or buyer information, including buyer filters, may be examined to find an optimal match. The sales lead information and/or buyer information may be examined according to a matching algorithm.

The matching algorithm may factor in one or more matching variables. The one or more matching variables may include revenue, cost, lead source, quality, buyer provided data, historical data, offline data and/or other data. The one or more matching variables may include variables associated with data received from buyers in response to receiving prior sales lead information.

Lead scores may be based on parameters. The parameters may be selected as being parameters most relevant to client needs. In some variations, parameters may be selected based on their relevance to a client's business needs. In other variations, parameters may weighted based on their relevance to a client's business needs. Adjustments may be made to the parameters depending on the specified required demographics for the sales leads. Adjusting the parameters in this manner facilitates providing clients with qualified sales leads in a timelier manner.

At 208, a representation of validated sales leads may be generated for delivery to a client, or buyer. The representation of validated sales lead information may be based on the validated sales lead information having a score above a minimum threshold. The minimum threshold may be a predetermined minimum threshold. The minimum threshold may be based on the sales lead information, the generated scores for the sales leads, the generated scores for the clients/buyers, and/or other information. In some implementations the minimum threshold for the generated score for a particular client/buyer may be dynamic. The minimum threshold may dynamically change based on any of the foregoing factors and/or other factors.

In some variations, the platform server(s) 102 may be configured to generate a bespoke data file comprising one or more fields for the information described herein. The bespoke data file may be encrypted to avoid parties not involved in the transaction from obtaining the information. In some variations, the proprietary file format may be readable by only those with permission and the software to read the file format.

Leads may be delivered to a client/buyer in any manner. For example, leads may be delivered to the client by third-party lead generation platforms, Email, File Transfer Protocol (push or pull), and/or other methods of delivery. A client may select the desired methods and/or formats of delivery of the sales lead information.

At 209, clients/buyers may provide sales lead performance data. The sales lead performance data may provide an indication of the performance of the sales leads delivered to the clients/buyers. The sales lead performance data may be used during the operations at 206 to facilitate scoring of the validated sales lead information. Subsequently to the clients/buyers providing the sales lead performance data, the sales lead performance data may be normalized to comply with the format used by the operations at 105. In some implementations, the normalized sales lead performance data may be merged with the originally received sales lead information.

In some variations, the sales lead performance data may be transmitted from the lead buyer server(s) 108 to the platform server(s) 102. The sales lead performance data may include information obtained by tracking the click-through-rate, the browsing habits of the sales lead after being sent advertising or a conversion message, or the like.

In some implementations, generating a score of the validated sales lead information at 206 includes generating a score for the validated sales lead information based on the received sales information.

In some implementations, sales lead information received from the sales lead sources may be tracked. Tracking of the sales lead information from a sales lead source may eventually provide an indication of the effectiveness of the sales lead source. In some implementations, at 203, a level of validity of the sales lead information may be determined. The level of validity of the sales lead information may be communicated to the sales lead source that provided the sales lead information.

The sales lead information may be tracked by the platform server(s) 102. The platform server(s) 102 may be configured to embed a code into the sales lead information when received from the sales lead source, such as the sales lead server(s) 106. The code can, in turn, be embedded into whatever the sales lead buyer generates to make a sale, or convert the sales lead. For example, the sales lead buyer may generate an email advertising goods or services that can be opened and clicked on, the sales lead buyer may make telephone calls to sales leads, or the like.

In some variations, the platform server(s) 102 can be configured to monitor the activities of sales leads. The platform server(s) 102 may obtain information associated with online purchases made by sales leads. The platform server(s) 102 may track online activities of sales leads. The platform server(s) 102 may receive information from lead buyer server(s) 108 related to activities of sales leads in response to a communication from the sales lead buying entity. The platform server(s) 102 may be configured to store this information, such as in electronic storage 114. The platform server(s) 102 may be configured to perform analysis on the collected sales lead information effectiveness and generate one or more sales lead reports based on the collected sales lead information.

In some implementations, a payment for the sales lead source may be determined. The amount of the payment for the sales lead information may be determined based on the level of validity of the sales lead information. In some implementations the amount of the payment for the sales lead information may be determined based on the sales lead performance information received from the client/buyer of the sales lead information.

In some implementations, a platform may be provided that includes a mechanism to create a new lead source. New lead sources may be created, for example, on a web page and/or by a web page owner. A record of the new lead source may be stored as a lead source for receiving sales lead information. Payment information associated with the new lead source may be provided and stored. The presently disclosed platform may generate an integration specification detailing how sales lead information data should be submitted to the platform. In some implementations, the lead source may comply with the integration specification. In other implementations, the platform may normalize the data provided by the lead source to make it comply with the integration specification. This integration specification may be provided for integrations of data from existing lead sources as well as new lead sources.

An integration system that facilitates normalizing the data in accordance with the integration specification may be executed and/or installed on third-party lead management platforms, client relationship management platforms, on a web page, in a call-center and/or other third party locations. In some implementations, the presently disclosed platform may create a specification-compliant web form for the lead source to use.

Sales lead information submitted by a given sales lead source may be attributed, by the platform, to that given sales lead source. This allows for tracking of the sales lead information submitted by individual sales lead sources. Other attributes associated with the sales lead information may be tracked. For example, the sales lead source may have created or may participate in one or more campaigns. The campaign information associated with the sales lead information may be tracked. Other attributes such as traffic source, creative identification, sub-source information and/or other attributes associated with the sales lead information may be tracked.

In some implementations, real-time notifications may be provided by the platform to the sales lead source. Such notifications may indicate the validity of the sales lead, whether the sales lead matched with one or more clients/buyers, whether the sales lead was sold to a client/buyer, the score associated with the sales lead and/or the client/buyer, and/or other metrics associated with the sales lead information.

Analyzing sales lead performance information provided by clients allows the lead management system to capitalize on inquiry applications by utilizing the information to create accurate analyses of conversion data. This analysis may facilitate the identification of specific lead sources, advertisements, webpages, and other sales generation elements that are not converting for clients. Thus the clients are able to focus on the highest-performing sales lead sources.

FIG. 3 is a process flow diagram 300 illustrating aspects of a method having one or more features consistent with implementations of the current subject matter. The operations illustrated in FIG. 3 may be performed by a platform configured to manage sales lead information. Such a platform may be managed and/or maintained by a platform server, such as platform server(s) 102.

At 301 partial sales lead information about a sales lead may be received by a lead management system platform. The partial sales lead information may be provided by a sales lead source. At 302 the partial sales lead information may be validated by the lead management system platform using one or more validation rules. At 303 the partial sales lead information may be scored and/or matched to a buyer of sales lead information. At 304 a request for a bid for the sales lead information may be sent by the lead management system platform to one or more buyers or clients. At 305 a bid for the sales lead information associated with the partial sales lead information may be received from a buyer or client by the lead management system platform. Providing partial sales lead information may avoid poaching by potential buyers/clients and/or may provide greater peace-of-mind to the sales lead source.

At 306, in response to receipt of a bid for the sales lead information, the lead management system platform may notify the sales lead source of a successful response from a buyer/client. The response may include an offer to sell the sales lead information for the bid price provided by the buyer/client. At 307, in response to an indication of acceptance by the sales lead source to the bid from the buyer/client, the lead management system platform may receive the rest of the sales lead information associated with the accepted bid price. In some variations, the lead management system platform may be configured to pull the information from the sales lead source. In some variations, the lead management system platform may be configured to request the information from the sales lead source. In some variations, the sales lead source may provide, or post, the rest of the sales lead information to the lead management system. In some variations, the sales lead source may provide, or post, the rest of the sales lead information directly to the buyer/client.

At 308, in response to the rest of the information being provided to the lead management system platform, the lead management system platform may validate the full sales lead information according to one or more validation rules. In some implementations, at 309, the lead source management system platform may augment the full sales lead information with previously obtained information and/or third party provided information.

At 310, in response to the full sales lead information being determined to be valid, it may be provided to the buyer/client. At 311 the sales lead source may be notified of the successful purchase and transfer of the sales lead information to the buyer/client. In some implementations, the notification may be through email, a webhook, a message and/or any other communication medium.

Should the transactions between the sales lead source and the lead management system platform, the sales lead source and the buyer/client, and/or the lead management system platform and the buyer/client fail at any time, the lead management system platform may be configured to cause a notification to be sent to the sales lead source providing an indication of the failure of the transaction.

In this manner, the lead management system platform may provide a digital lead auction for sales leads. The delivery of the sales lead information may be determined by the buyers and/or sellers.

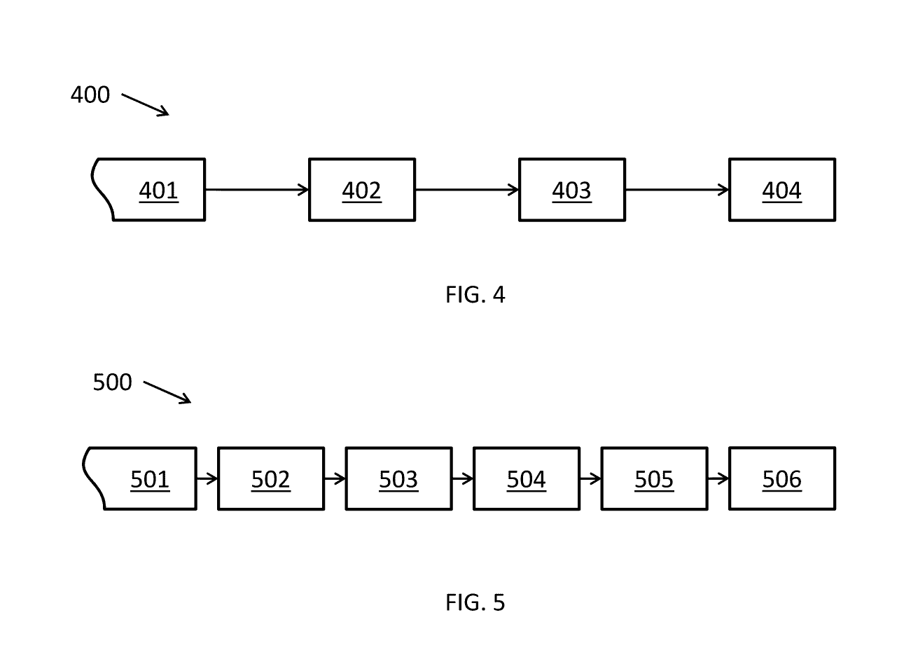

FIG. 4 is a process flow diagram 400 illustrating aspects of a method having one or more features consistent with implementations of the current subject matter. The operations illustrated in FIG. 4 may be performed by a platform configured to management sales lead information.

At 401, the lead management system platform may provide an email account for a sales lead source. The email account may be configured to receive submissions of sales lead sources by the sales lead source. The email account may be controlled by the lead management system platform. At 402, the sales lead source may submit an email to the provided email account containing at least some sales lead information. At 403, the lead management system may be configured to parse text from the email body received from the sales lead source. At 404, a determination may be made as to whether the text format parsed from the email body conforms to one or more integration specifications associated with the lead management system. Such integration specifications may have been provided to the sales lead source. In some implementations, the integration specifications may be specific to the type of sales lead, the type of sales lead source, the sales lead source, and/or other parameters. In response to an indication that the sales lead information provided at 402 conforms with one or more integration specifications, the lead management system may process the sales lead information. The sales lead information may be processed in accordance to process 200 illustrated in FIG. 2 and/or in accordance to process 300 illustrated in FIG. 3.

FIG. 5 is a process flow diagram 500 illustrating aspects of a method having one or more features consistent with implementations of the current subject matter. The process flow illustrated in FIG. 5 may be performed by a lead management system.

At 501 performance data can be provided by one or more buyers/clients. The performance data associated with the performance of sales lead sources previously provided to the buyers/clients. The performance data may be provided in one or more data formats that conform to one or more integration specifications. For example, the performance data may be provided in a text file, a CSV file, in raw format, and/or other formats. The performance data may be arranged in an order that conforms to one or more integration specifications.

At 502, the lead management system may receive the performance data provided by one or more buyers and/or clients.

At 504, lead performance data received from the client(s)/buyer(s) may be associated with lead data stored within the lead management system.

At 505, the lead performance data received from the client(s)/buyer(s) may be used to score the lead data stored within the lead management system.

At 506, the scored lead data may be fed into scoring and matching algorithms for use at 206 and/or 207, for example.

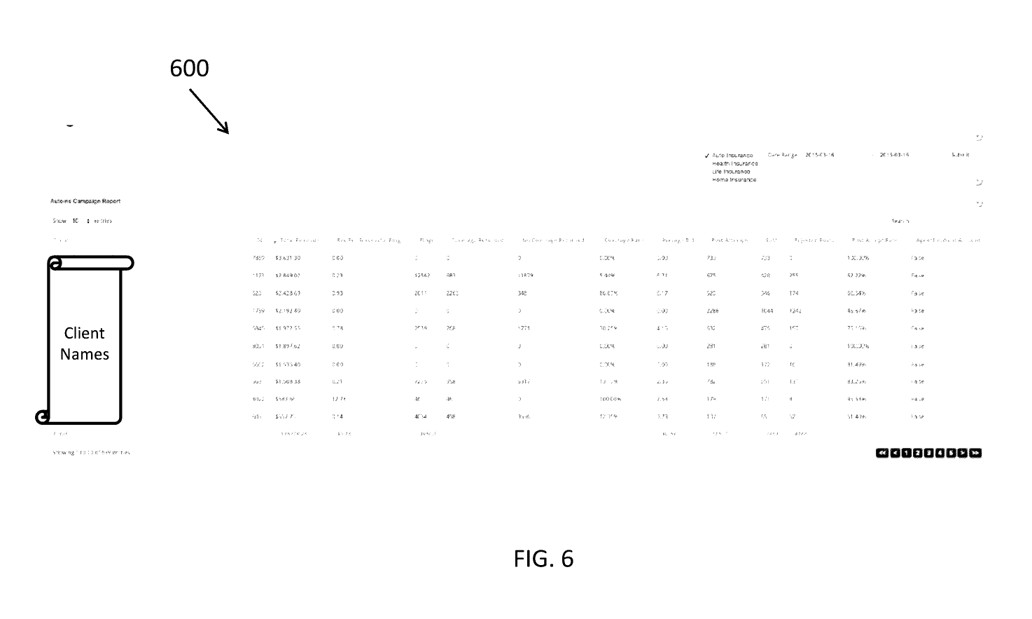

The lead management system may be configured to generate reports. The reports may be generated on a graphical user interface of a display associated with the platform server(s) 102. The display may be associated with a user device(s) 112. The display may be associated with a sales lead server(s) 106, lead buyer server(s) 108, or the like. Examples of some of the reports generated are described in relation to FIGS. 6-11.

FIG. 6 is an illustration 600 of lead information across verticals and lead clients that have been generated by a lead management system capable of performing one or more of the operations described herein. The report in illustration in 600, can be filtered by industry. The report can be filtered by data range for the sales leads. The report can include the name of the client, an ID assigned to the client, total revenue generated from that client, revenue per ping for the client, the average bid from the client for sales lead information, number of post attempts by the client, amount of sales lead information sold to the client, rejections by the client, sales lead information acceptance rate for the client, and/or other information associated with the client.

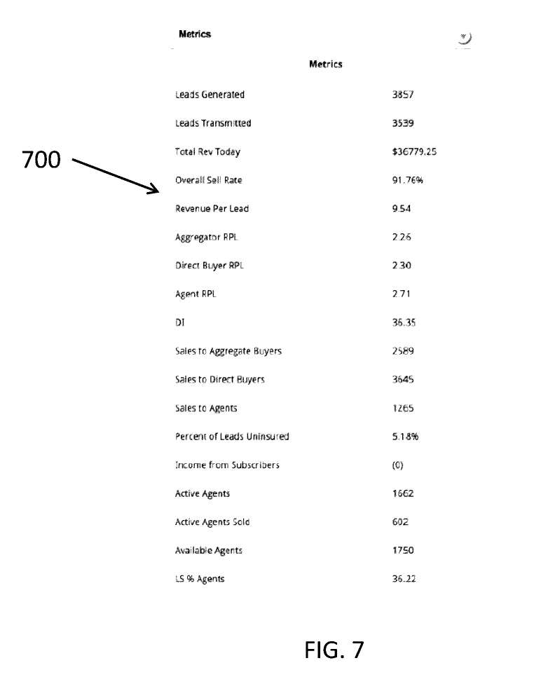

FIG. 7 is an illustration 700 of key performance indicators for sales leads that have been generated by a lead management system capable of performing one or more of the operations described herein. The key performance indicators can be selected by an administrator. The key performance indicators can be filtered by industry, individual companies, or the like.

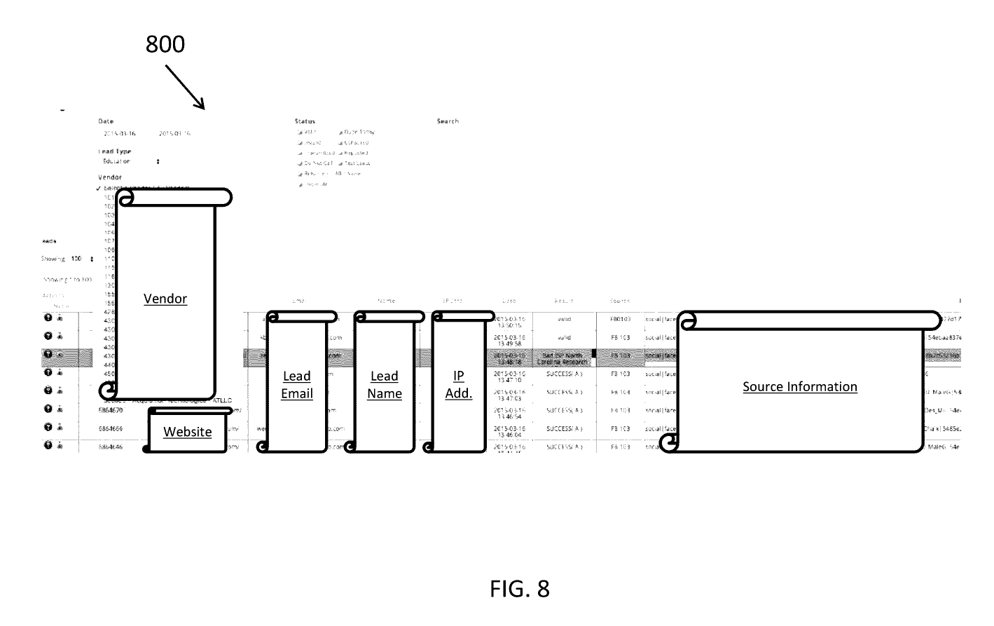

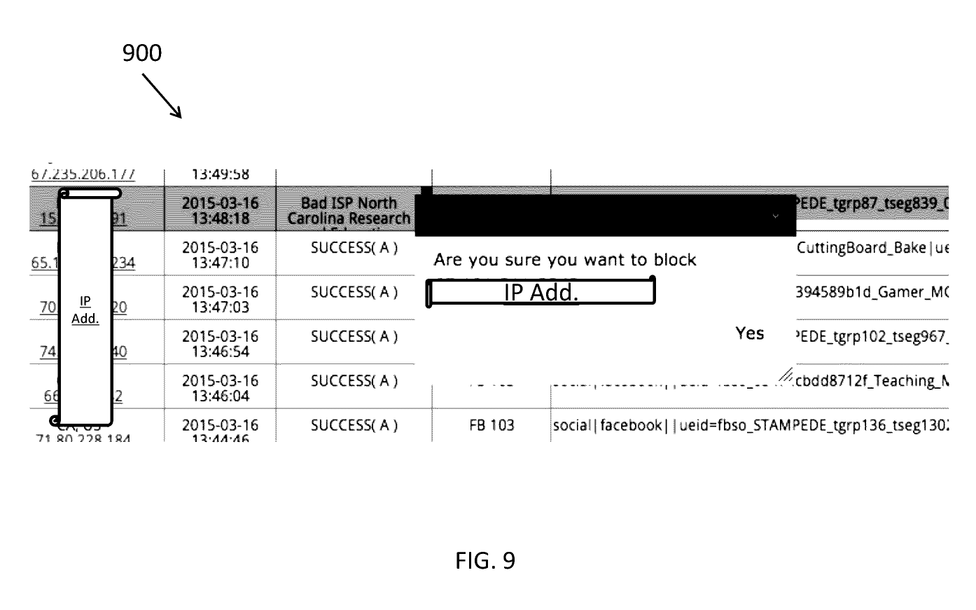

FIGS. 8 and 9 are illustrations 800 and 900 of leads that have been received and filtered by a lead management system capable of performing one or more of the operations described herein. The reports provided in illustrations 800 and 900 can include information associated with the sales leads. The information can include an email address, an originating IP address, browser information used by the sales lead, operating system information used by the sales lead, a time at which the sales lead interacted with the sales lead source, a name associated with the sale lead, an identification number associated with the sales lead, a result associated with the sales lead, sales lead source information associated with the sales lead, or the like.

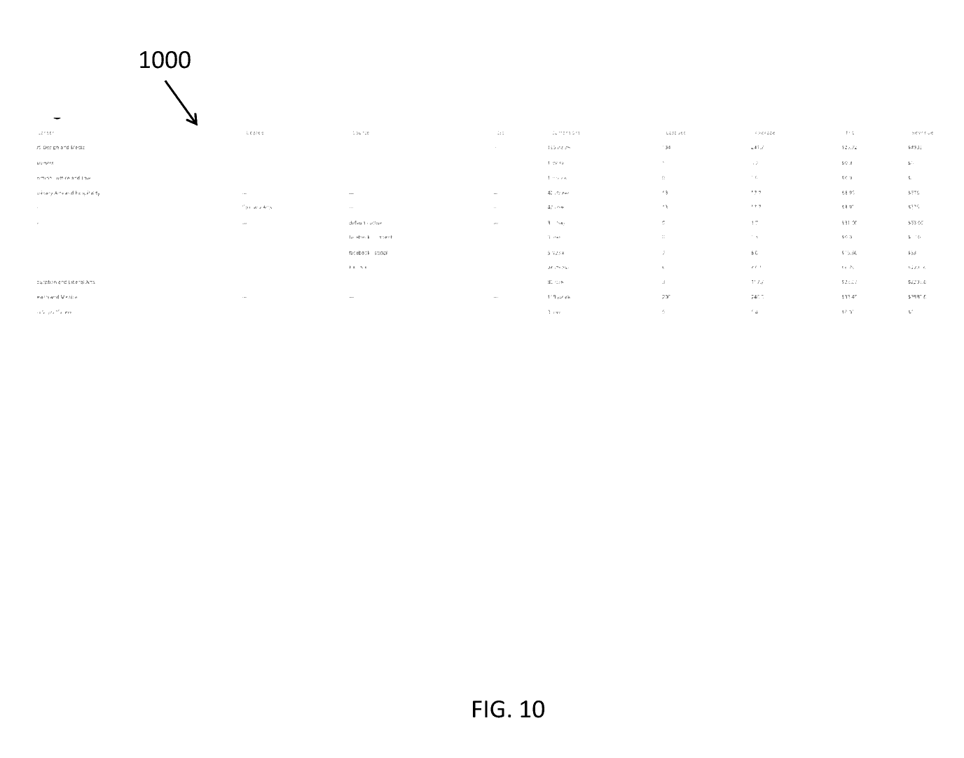

FIG. 10 is an illustration 1000 of lead metrics filtered by different lead attributes that have been generated by a lead management system capable of performing one or more of the operations described herein. The reports provided in illustration 1000 can include information associated with the sales leads. The reports can include an indication of a current status of the sales lead, a future status of the sales lead, or the like. The reports can include an indication of the product or service likely to be bought by the sales lead, or the like.

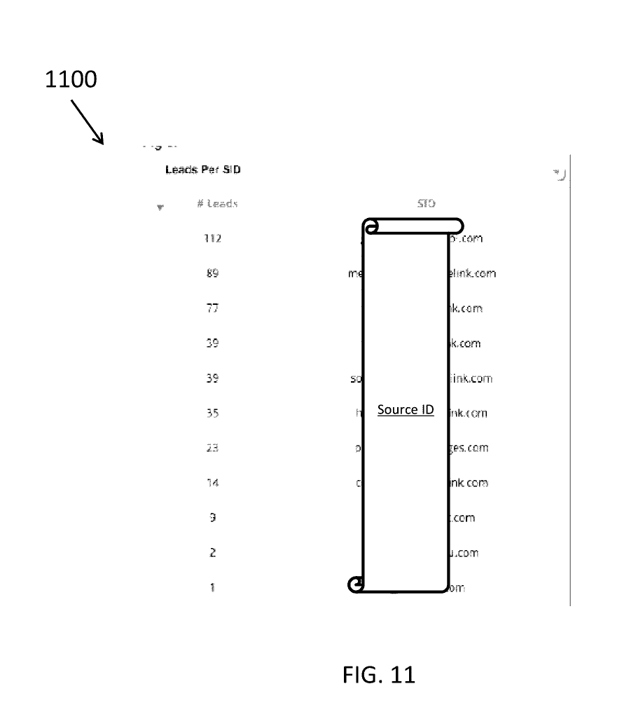

FIG. 11 is an illustration 1100 of leads received by a lead management system capable of performing one or more of the operations described herein. The report of illustration 1100 can include an indication of a sales lead source. The indication can be a numerical identification, a name, or the like. The report of illustration 1100 can include an indication of the amount of sales lead information provided by the sales lead source, or the like.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method to be performed by at least one data processor forming at least part of a computing system, the method comprising:
receiving, by the at least one data processor, sales lead information over the Internet from an online sales lead source;
executing, by the at least one data processor, one or more validation rules implemented in executable software, the validation rules normalizing a format and/or identity of the sales lead information to validate at least some of the sales lead information based on the one or more validation rules and to generate validated sales lead information;
executing, by at least one data processor, a scoring algorithm calculating a score based on one or more attributes of the validated sales lead information to generate a score for each of the validated sales lead information according to the scoring algorithm; and,
generating, by at least one data processor for delivery to a client having a user display, a representation of validated sales leads based on the validated sales lead information having a score above a minimum threshold, the validating of the at least some sales lead information putting the at least some of the sales lead information into a format displayable on the display.

2. The method in accordance with claim 1, wherein the format displayable on the display includes a data file having one or more data fields, individual ones of the data fields including a code readable by a client device associated with the client.

3. The method in accordance with claim 1, wherein the one or more validation rules includes cross-referencing at least some of the sales lead information against information provided by a third party to normalize the format and/or identity of the sales lead information.

4. The method in accordance with claim 1, wherein the one or more validation rules includes cross-referencing at least some of the sales lead information against one or more information databases to normalize the format and/or identity of the sales lead information.

5. The method in accordance with claim 1, further comprising;
receiving, by at least one data processor, sales information from the client, and wherein generating a score of the validated sales lead information includes generating a score for the validated sales lead information based on the received sales information.

6. The method in accordance with claim 1, further comprising:
augmenting, by at least one data processor, in response to validating at least some of the sales lead information, the sales lead information by integrating at least some of the sales lead information with information obtained from one or more information databases.

7. The method in accordance with claim 1, wherein generating the validated sales lead information for delivery to a client is performed, by at least one data processor, in response to one or more predefined triggers.

8. The method in accordance with claim 1, wherein the sales lead source includes one or more of: web-based forms, third-party client relationship management software, third-party lead management software, a call center, and/or a web page.

9. The method in accordance with claim 1, further comprising:
tracking, by at least one data processor, sales lead information received from the sales lead source.

10. The method in accordance with claim 1, further comprising:
providing, by at least one data processor, an indication of the validity of at least some of the sales lead information to the sales lead source that provided the sales lead information.

11. The method in accordance with claim 1, wherein the lead validated sales lead information is delivered to the client by one or more of electronic mail, POST, GET, Ping/Post, Push FTP, and/or Pull FTP.

12. The method in accordance with claim 1, further comprising:
determining, by at least one processor, in response to validating the sales lead information and generating a score for the validated sales lead information that is in excess of a minimum threshold, a client for the validated sales lead information;
electronically offering, by at least one processor, a bid price from the client to the sales lead source; and,
receiving, by at least one processor, an acceptance of the offer from the sales lead source, and wherein delivering the validated sales lead information to the client is performed in response to receiving the acceptance of the offer from the sales lead source.

13. The method in accordance with claim 10, wherein the sales lead information provided by the sales lead source prior to validation contains partial sales lead information and wherein the sales lead information provided to the client in response to receiving an acceptance of the offer from the sales lead source includes full sales lead information.

14. The method in accordance with claim 1, wherein receiving, by at least one data processor, sales lead information from a sales lead source further comprises:
providing, by at least one processor, to the sales lead source an electronic messaging address, the electronic messaging address configured to receive lead source information from the sales lead source; and,
verifying, by the at least one processor, that the lead source information submitted to the electronic messaging address complies with a predetermined specification.

15. The method in accordance with claim 1, wherein receiving, by at least one data processor, sales lead information from a sales lead source further comprises:
polling, by at least one processor, an internet location associated with the sales lead source for sales lead information; and,
parsing, by at least one processor, sales lead information from the internet location associated with the sales lead source.

16. A system for managing sales lead information comprising one or more physical processors configured to implement one or more computer instructions to perform the following operations:
receive, by the one or more physical processors, sales lead information over the Internet from an online sales lead source;
executing, by the one or more physical processors, one or more validation rules implemented in executable software, the validation rules normalizing a format and/or identity of the sales lead information to validate at least some of the sales lead information based on the one or more validation rules and to generate validated sales lead information;
executing, by the at least one data processor, a scoring algorithm calculating the score based on one or more attributes of the validated sales lead information to generate a score for each of the validated sales lead information according to the scoring algorithm; and,
generate, by the one or more physical processors, for delivery to a client having a user display, a representation of validated sales leads based on the validated sales lead information having a score above a minimum threshold, the validating of the at least some of the sales lead information putting the at least some of the sales lead information into a format displayable on the display.

17. The system of claim 16, wherein the format displayable on the display includes a data file having one or more data fields, individual ones of the data fields including a code readable by a client device associated with the client.

18. The system of claim 16, wherein the one or more validation rules includes cross-referencing at least some of the sales lead information against information provided by a third party to normalize the format and/or identity of the sales lead information.

19. The system of claim 16, further comprising:
augmenting, by at least one data processor, in response to validating at least some of the sales lead information, the sales lead information by integrating at least some of the sales lead information with information obtained from one or more information databases.

20. The system of claim 16, wherein the one or more computer processors are further configured to:
determine, by at least one processor, in response to validating the sales lead information and generating a score for the validated sales lead information that is in excess of a minimum threshold, a client for the validated sales lead information;
electronically offer, by at least one processor, a bid price from the client to the sales lead source; and,
receive, by at least one processor, an acceptance of the offer from the sales lead source, and wherein delivering the validated sales lead information to the client is performed in response to receiving the acceptance of the offer from the sales lead source.
